(19) United States
(12) Patent Application Publication
(10) Pub. No.: US 2013/0314946 A1
(43) Pub. Date: Nov. 28, 2013

(54) AUTOMOTIVE HEADLAMP ASSEMBLY

(71) Applicants: Terrence J. Wilson, Melvindale, MI (US); Stephen K. Helwig, Farmington Hills, MI (US); Sleiman N. Abdelnour, Macomb, MI (US)

(72) Inventors: Terrence J. Wilson, Melvindale, MI (US); Stephen K. Helwig, Farmington Hills, MI (US); Sleiman N. Abdelnour, Macomb, MI (US)

(73) Assignee: FORD GLOBAL TECHNOLOGIES, LLC, DEARBORN, MI (US)

(21) Appl. No.: 13/478,193

(22) Filed: May 23, 2012

(51) Int. Cl. F21V 8/00

(52) U.S. Cl. 362/612; 362/613

(57) ABSTRACT

A headlamp assembly includes a bezel defining a first surface and a second surface inclined with respect to the first surface and located at an outboard periphery, a series of fingers separated by slots, each slot extending through the first surface and the second surface, light sources, and light guides, each light guide fitted into one of the slots, for transmitting light from one of the light sources, along and through one of the slots.

### BACKGROUND OF THE INVENTION

This invention relates generally to a headlamp for a motor vehicle, the headlamp incorporating unique accent lighting and a bezel assembly configuration.

### SUMMARY OF THE INVENTION

A headlamp assembly includes a bezel defining a first surface and a second surface inclined with respect to the first surface and located at an outboard periphery, a series of fingers separated by slots, each slot extending through the first surface and the second surface, light sources, and light guides, each light guide fitted into one of the slots, for transmitting light from one of the light sources, along and through one of the slots.

The headlamp assembly includes no cut-outs in the bezel for allowing light to bleed through, thereby preventing the light source being visible in a non-light condition and providing a jewel-crystal look having a clear lens.

The headlamp assembly includes no black and clear co-mold design, thereby helping to achieve the jewel-crystal look and avoiding absorption of light by the black portion. Consequently the assembly provides a uniform distribution of light.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a perspective side view of an automotive a headlamp assembly installed in a motor vehicle;

FIG. 2 is a perspective view of the automotive a headlamp assembly installed in a motor vehicle;

FIG. 3 is a perspective view of a bezel for the headlamp assembly of FIGS. 1 and 2;

FIG. 4 is a perspective view of light guides for the headlamp assembly of FIGS. 1 and 2;

FIG. 5 is a perspective cross section through the bezel and a chrome surround showing a light guide and LED; and

FIG. 6 is a perspective cross section through the bezel and a chrome surround an alternate light source location for a light guide; and

FIG. 7 is a perspective view of the assembled headlamp assembly of FIGS. 1 and 2.

### DESCRIPTION OF THE PREFERRED EMBODIMENT

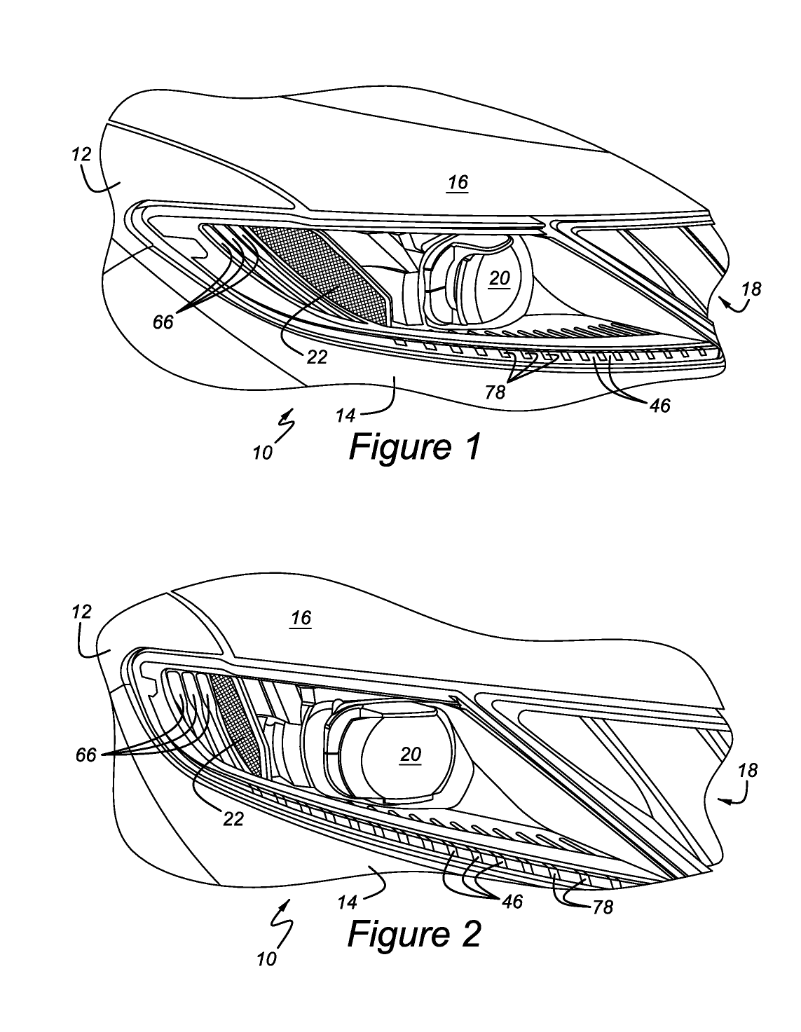

FIGS. 1 and 2 are perspective views of an automotive headlamp assembly 10 installed in a motor vehicle showing the vehicle's side panel 12, fascia 14, hood 16, grille 18, projector module 20, side reflex 22, and light guides 62, 66. The projector module 20 is the primary source of light produced by the headlamp assembly 10. The side reflex is a yellow colored surface with reflex pins on the B-side that provides reflectivity when light is shone against it.

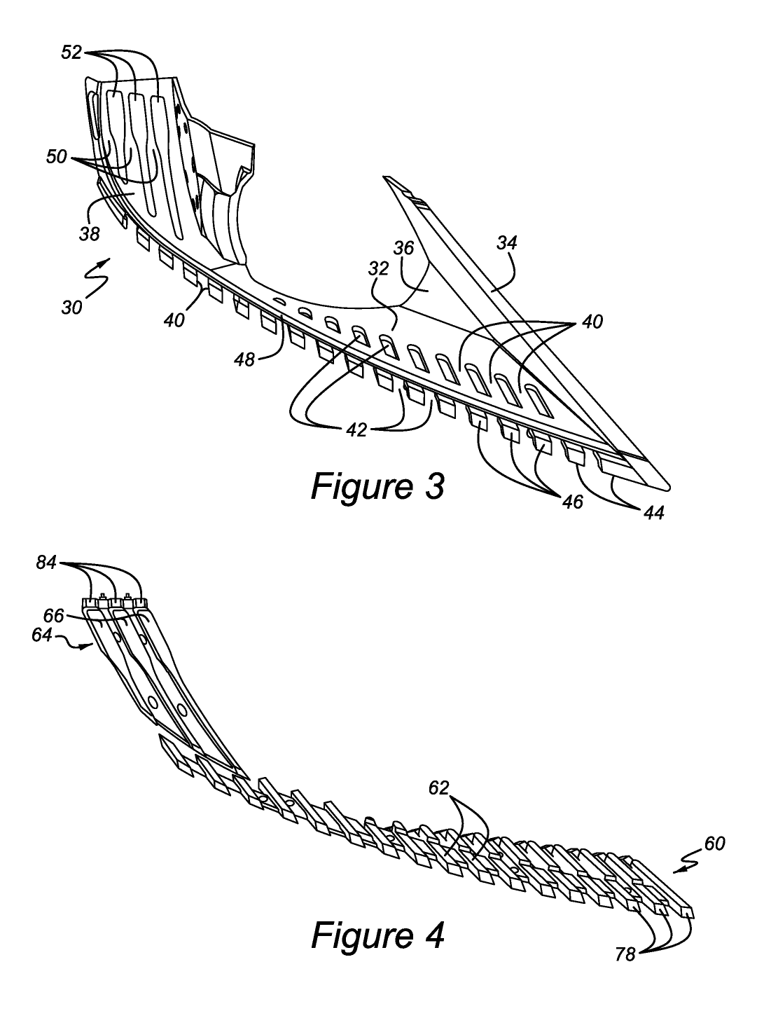

FIG. 3 is a perspective view of the headlamp assembly's bezel 30, which is preferably formed of molded plastic. The bezel 30 includes a first surface 32; an inboard wall 34; a transition surface 36, extending between surface 32 and inboard wall 34; and a third surface 38, inclined upward and rearward with respect to first surface 32.

Surface 32 is formed with a series of first fingers 40 separated by slots 42, each slot 42 extending through a thickness of surface 32 and extending to an outboard periphery 44 of the bezel 30. Preferably the tip of each finger 40 at the outer periphery 44 terminates at a second surface 46, which is inclined downward and forward with respect to first surface 32. An outboard stiffener 48, interconnecting the fingers 40, provides structural continuity between the fingers 40 and stability to the bezel assembly 30.

Third surface 38 is formed with a series of second fingers 50 separated by second slots 52, each second slot 52 extending through a thickness of surface 38 and along a length of surface 38. Due to the inclination of third surface 38 relative to first surface 32, slots 52 also extend rearward and upward.

FIG. 4 shows an assembly 60 of light guides 62, each light guide 62 able to fit into one of the first slots 42.

FIG. 4 also shows an assembly 64 of second light guides 66, each second light guide 66 able to fit into one of the second slots 52.

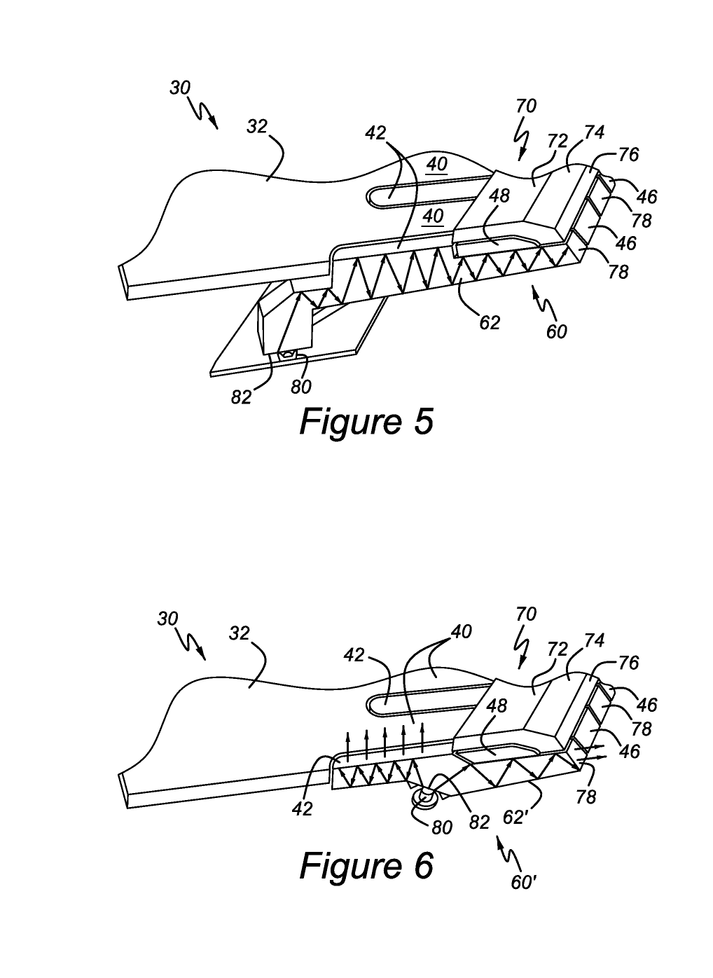

FIG. 5 is a perspective cross section through surface 32 and outboard stiffener 48 of the bezel 30. A chrome surround 70 having a bright outer surface overlaps the stiffener 48. The chrome surround 70 is formed with an upper surface 72, a transition surface 74 and an inclined surface 76. When the chrome surround 70 is installed in headlamp assembly 10, the plane of the inclined surface 76 is substantially aligned with or parallel to the plane of the inclined surfaces 46 at the tip of each finger 40.

Similarly, when the light guide assembly 60 is installed in headlamp assembly 10, the plane of the inclined surfaces 78 is substantially aligned with or parallel to the plane of the inclined surfaces 46 at the tip of each finger 40 and the plane of the inclined surfaces 76 of the chrome surround 70.

Each of a series of semiconductor light sources 80, such as a light emitting diode (LED), is located at the entrance 82 of each of the light guides 62 of the light guide assembly 60 and at the entrance of each of the light guides 66 of the light guide assembly 64. Each of the light guides 62, 66 transmits light from the LED 80, such that light passes through one of the slots 42, 52 in surfaces 32, 38, respectively, of bezel 30. Light transmitted through light guide assembly 60 also passes through each of the forward facing inclined surfaces 78 of the light guide assembly 60.

In the cross section through the bezel 30, chrome surround 70 and light guide assembly 60′ shown in FIG. 6, the LED 80 is located at an intermediate location along the length of the light guide 62′. Light from LED 80 is transmitted along light guide 62 in both directions, thereby providing light of more uniform intensity along the length of the light guide 62.

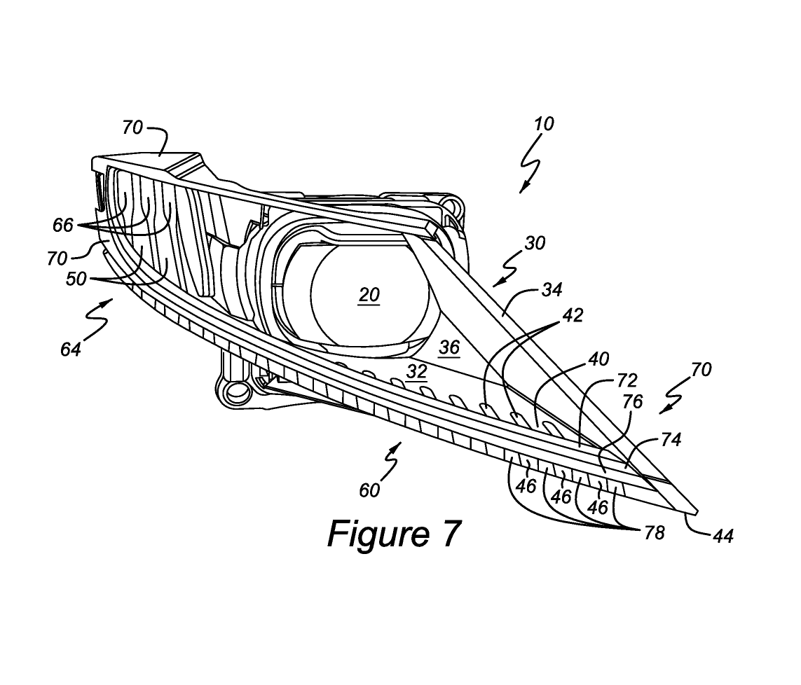

FIG. 7 shows the assembled headlamp assembly 10 with the projector module 20 located in the assembly and supported on the body of the vehicle. The illuminated inclined surfaces 78 of light guides 62 are distributed along the outboard periphery 44 of the bezel 30, the illuminated upper surfaces of light guides 62 are directed upward through the slots 42 in surface 32 of bezel 30, and the illuminated inclined surfaces of light guides 66 are visible through the slots 52 in inclined surface 38 of bezel 30. The chrome surround 70 overlaps the outboard stiffener 48 and extends along the upper, lower and lateral peripheries of the headlamp assembly 10. As FIG. 7 illustrates, the chrome surround 70 produces a structural connection between the inboard wall 34 and the upper edge of third surface 38, thereby providing structural continuity across the upper portion of the bezel 30.

In accordance with the provisions of the patent statutes, the preferred embodiment has been described. However, it should be noted that the alternate embodiments can be practiced otherwise than as specifically illustrated and described.

1. A headlamp assembly, comprising:
a bezel including a first surface having forward-directed slots, fingers mounted under the first surface, each finger spaced mutually by a second slot, including a second surface inclined relative to the first surface;
light sources;
light guides, each light guide transmitting light from one of the light sources, fitted into one of the slots and one of the second slots, between consecutive second surfaces.

2. The headlamp assembly of claim 1, wherein each light source transmits light in one of the light guides through one of the slots.

3. The headlamp assembly of claim 1, wherein each light source is a semiconductor light source.

4. The headlamp assembly of claim 1, further comprising a stiffener interconnecting the fingers, located near an outboard end of each finger, spanning the slots, and extending along an outboard periphery.

5. The headlamp assembly of claim 4, further comprising a surround that overlaps at least a portion of a length of the stiffener.

6. The headlamp assembly of claim 1, wherein:
the bezel further comprises a third surface inclined upward and rearward with respect to the first surface, a second series of fingers separated by second slots, each second slot extending through the third surface;
second light sources;
second light guides, each light fitted into one of the second slots, for transmitting light from one of the second light sources, along and through one of the second slots.

7. The headlamp assembly of claim 6, further comprising:
an inboard wall;
a member that connects the inboard wall and the third surface.

8. The headlamp assembly of claim 1, further comprising a side reflex.

9. The headlamp assembly of claim 1, further comprising a projector module that provides a primary source of light from the headlamp assembly.

10. A headlamp assembly, comprising:
a bezel including a first surface having forward-directed slots, fingers mounted under the first surface, each finger spaced mutually by a second slot, including a second surface inclined with respect to the first surface and located at an outboard periphery, each slot extending through the first surface and a third surface inclined upward and rearward with respect to the first surface, a second series of fingers separated by third slots, each third slot extending through the third surface;
light sources;
light guides, each light guide fitted into one of the slots and one of the second slots, between consecutive second surfaces, for transmitting light from one of the light sources, along and through one of the slots;
second light guides, each light fitted into one of the third slots, for transmitting light from one of the light sources, along and through one of the third slots.

11. The headlamp assembly of claim 10, wherein each light source is a semiconductor light source.

12. The headlamp assembly of claim 10, further comprising a stiffener interconnecting the fingers, located near an outboard end of each finger, spanning the slots, and extending along said outboard periphery.

13. The headlamp assembly of claim 12, further comprising a surround that overlaps at least a portion of a length of the stiffener.

14. The headlamp assembly of claim 10, further comprising:
an inboard wall;
a member that connects the inboard wall and the third surface.

15. The headlamp assembly of claim 10, further comprising a side reflex.

16. The headlamp assembly of claim 10, further comprising a projector module that provides a primary source of light from the headlamp assembly.

17. A headlamp assembly, comprising:
a bezel including a first surface located in a substantially horizontal plane, having forward-directed slots, fingers mounted under the first surface, each finger spaced mutually by a second slot, including a second surface inclined with respect to the first surface;
light emitting diodes (LED);
light guides, each light guide fitted into one of the slots, for transmitting light from one of the LEDs, along and through one of the slots and one of the second slots between consecutive second surfaces.

18. The headlamp assembly of claim 17, further comprising a stiffener interconnecting the fingers, located near an outboard end of each finger, spanning the slots, and extending said an outboard periphery.

19. The headlamp assembly of claim 17, wherein:
the bezel further comprises a third surface inclined upward and rearward with respect to the first surface, a second series of fingers separated by third slots, each third slot extending through the third surface;
second light sources;
second light guides, each light fitted into one of the third slots, for transmitting light from one of the second light sources, along and through one of the third slots.

20. The headlamp assembly of claim 19, further comprising:
a stiffener interconnecting the fingers, located near an outboard end of each finger, spanning the slots, and extending along said outboard periphery;
an inboard wall; and
a member that overlaps at least a portion of a length of the stiffener and connects the inboard wall and the third surface.
